(19) United States
(12) Patent Application Publication
(10) Pub. No.: US 2006/0168937 A1
(43) Pub. Date: Aug. 3, 2006

(54) Magnetic monopole spacecraft

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 11/048,026

(22) Filed: Jan. 31, 2005

(51) Int. Cl. F03H 1/00

(52) U.S. Cl. 60/203.1

(57) ABSTRACT

A spacecraft propulsion system that utilizes a dual method of providing lift on the hull by means of magnetic monopoles and electromagnetic spacetime curvature pressure.

### BRIEF SUMMARY OF THE INVENTION

This invention is a spacecraft propulsion system that generates a field of wormholes which are threaded with a magnetic field. Acting as two attracting magnets, the spacecraft's north magnetic field is attracted to the constantly regenerating south magnetic monopoles of the wormholes which provides lift on the hull.

### BACKGROUND OF THE INVENTION

According to one of Maxwell's electromagnetic equations, the curl of the electric E field is equal to the negative time rate of change of the magnetic flux density B field.

$$\overline{V} \times E = - \frac{\partial B}{\partial t}$$

The curl can be thought of as a circulation around a closed loop specified by the right-hand rule where the fingers curl in the direction of the electric field and the thumb represents the changing magnetic flux density field through the area of the loop. At no time is the electric field diverging around the loop. That is, the divergence of the curl is zero which is a well-known vector operation

$$div curl E = \frac{\partial }{\partial t} ( div B ) = 0$$

The partial derivatives of divB are zero at all points in space. Performing the integration, therefore, the divergence of B is equal to a constant
div B=constant

Referring to FIG. 1, the following discussion is made in cylindrical coordinates {r,θ,z}. In cylindrical coordinates, the divergence of the radial B field, div B, is equal to a constant C

$${Br}^{′} [ r ] + \frac{Br [ r ]}{r} = C$$

where the prime (′) represents differentiation with respect to the radius r. The solution to this equation resides in determining the constant C. In the vacuum of space without any wormholes, the constant C is zero. Because the spacecraft is surrounded by a field of wormholes, there is a magnetic flux density field threading each one. That is, each wormhole is actually a magnetic monopole, and therefore the entire field of monopoles constitutes a large magnet with one pole in this dimension and the other pole in the hyperspace dimension.

The concept of the wormhole involves a new type of scientific thinking involving the creation of a gateway between our spacetime and that of a hyperspace co-dimension. The gateway is created electromagnetically as shown by my patent applications Rotating Magnetic Vortex Generator, Magnetic Vortex Wormhole Generator, and Sulfur 8 Wormhole Generator. The gateway can also be created ultrasonically through bubble cavitation as shown in my patent application Cavitating Oil Hyperspace Energy Generator. In one experiment, smoke was blown through one side of the coil of the magnetic vortex wormhole generator and no smoke came out the other side. The smoke was blown through the wormhole into another dimension.

The existence of hyperspace is not generally known in the scientific community. The reason it exists can be thought of in the following manner. Referring to FIG. 2, the corners of a tetrahedron (2) circumscribed by a sphere (1) touch the sphere at an angle (3) of −19.47°. Looking at the planets of the solar system, the Giant Red Spot vortex of Jupiter, which can hold two planets the size of Earth, is located at this angle. On Mars, the Olympic Mons volcano, which is the size of France, is located at north 19.5° Here in the Caribbean there is a slow moving rock mantle vortex at north 19.5° that curves the islands down toward Venezuela. So the geometry of space is related to the tetrahedron. What this suggests is that there is a subspace manifold whose tetrahedral geometry projects all the constants of physics into our dimension.

Referring to FIG. 3, this subspace geometry is shown in the tetrahedron diagram which plots the natural logarithm of mass on the vertical axis versus the natural logarithm of wavelength on the horizontal axis. With this diagram, it is possible to visualize the entire universe on a single sheet of paper. Triangle (4) is the tetrahedron whose vertical centerline shown by the small π circle (a) is equal to Planck's constant h divided by the speed of light c, known as the base constant. The base constant in logs is equal to −95.91546344. Line (5) is the diameter of the sphere (6). A circle (7), centered on (a), with a radius equal to the speed of light squared, is tangent to the tetrahedron. It can be shown that all the constants of physics, such as the speed of light squared and the Planck mass and the Planck wavelength, are determined geometrically by this logarithmic subspace tetrahedral geometry.

Referring to FIG. 4, the complex plane consists of a real horizontal axis, and a complex vertical axis where the value of the complex number z is given by a radius r and an angle θ
z=re^{i(θ+2πm)}
The logarithm of z is
Log[z]=Log[r]+i(θ+2πm)
where m is an integer m=0,1,2 . . . corresponding to multiple rotations of 2π. What this means in terms of the tetrahedron diagram, referring to FIG. 5, is that there are multiple diagrams separated by 2π rotations. Each multiple is another hyperspace dimension. Only the log manifold has this characteristic. Referring to FIG. 6, the hyperspace dimension, shown as 2π circular surface (8), has a cut (9) on the undefined Log[0] origin line such that another hyperspace dimension is created below it (10).

Referring to FIG. 7, this branch cut does not bring one back to the original surface nearing the origin. It takes one down to another level of the universe into another hyperspace dimension. I can attest personally that I have been able to look into another hyperspace co-dimension as well as jump into another dimension.

Furthermore, Dr. Stephen Hawking of Cambridge University has shown that our dimension is connected to a wormhole through complex time. That is, the hyperspace dimension is rotated forward by 90° which makes it orthogonal to us. While this is the mathematical explanation as to why there are hyperspace co-dimensions, I can attest personally to the fact, as described in my patent application Full Body Teleportation, that I was teleported through hyperspace and returned to our dimension over a distance of 100 meters. Because hyperspace exists, it is then possible, using electromagnetic fields, to open wormholes between our dimension and other hyperspace dimensions.

Referring to FIG. 8, the constant C in the magnetic flux density B field equation is determined as follows. The end of a solenoid (11) is equivalent to a local magnetic source of flux Φ which represents the wormhole. A charge (12) encircling the solenoid has the same value at P₁ and P₂ but there is a phase difference of 2 π n where n is an integer equal to the number of times the charge encircles the solenoid. The change in phase is equal to the charge q divided by Planck's reduced constant times the flux for a solenoid of radius r=R

$$Δθ = 2 π n = \frac{q}{ℏ} Φ = \frac{q}{ℏ} {BπR}^{2}$$

Solving for the magnetic flux density field threading the wormhole

$$B = \frac{2 π nh}{{qπR}^{2}}$$

The differential equation becomes

$${Br}^{′} [ r ] + \frac{Br [ r ]}{r} = C [ 2 ]$$

Solving the equation for the radial field Br

$$Br [ r ] = \frac{C [ 2 ] r}{2} + \frac{C [ 1 ]}{r}$$

Equating this Br field with the B field and solving for the C[2] constant

$$C [ 2 ] = \frac{- 2 [ - 2 ℏ n + qrC [ 1 ] ]}{{qr}^{2}}$$

Substituting for C[2], the C[1] constant drops out and therefore the wormhole magnetic flux density field becomes a constant inside the throat radius R

$$Br = \frac{2 hn}{{qR}^{2}}$$

but the divergence moving from outside to inside the radius is a constant due to the discontinuity.

Referring to FIG. 9, the wormhole has a constant cylindrically-shaped magnetic field of radius R with a negative south pole due to the negative charge on the electron, Using a wormhole radius equal to one hundred times the electron radius with n equal to 10 turns, the magnetic flux density B field has a magnitude of 1.4×10⁶ tesla.

Referring to FIG. 10, the wormhole surface (14) is a connection through a throat area (20) between space and hyperspace (13) to another surface in hyperspace (15). The electron path (19) is actually spiraling down the surface of the wormhole. The magnetic flux density field (18) points into the wormhole such that the cross product of the electron velocity (16) with the field (v×B) points toward the outside rim of the wormhole. Because the electron has a negative charge, the force (17) on the electron (−q v×B) is inward toward the centerline of the wormhole. Since one pole of the field is in space, and the other pole is in hyperspace, the wormhole appears to us as a magnetic monopole. The key to this invention is how to generate this magnetic wormhole field.

Referring to FIG. 11, the aluminum spacecraft is constructed of a flattened, shallow spherical lower hull (21), a circular upper hull with a flat sloping surface (22), a spherical dome cupola (23), and a cylindrical section (24) housing a circular array of radial microwave waveguides. Surfaces (22) and (23) are electrically charged, using high-voltage transformers, to an alternating electrostatic potential such that the potential on the dome is +V when the sloping hull has a −V potential and vice versa. This creates an electric field from the positively charged surface to the negatively charged surface.

Referring to FIG. 12, the dome (25) is charged to a positive potential. The spherical potential lines (26) emanate from the dome and curve around toward the sloping hull. The negative gradient of this potential field is the electric E field (27) which is perpendicular to the potential lines. The electric field lines from the dome then terminate on the sloping hull which can be seen in the lower right hand comer of the graph.

Looking down from above at the top of the dome, referring to FIG. 13, the oscillating electric field generates a circular oscillating magnetic field around the hull at various elevations. The last two graphs in the right-hand comer are near the top of the dome as seen by the smaller radius contour lines.

Referring to FIG. 14, the oscillating electric field lines (28) are between the dome and the sloping hull. The oscillating magnetic field (29) encircles the hull at the level of the microwave waveguides.

From gravitation physics, it is known that negative energy is required to open up the throat of the wormhole. In terms of differential forms mathematics, the negative energy is created by wedging the magnetic field with the radial microwave beams of the waveguides. This generates an increasing time rate of change of negative energy ρ as shown by

$$* d ( B \hat{} ( {B}_{wave} + {E}_{wave} dt ) ) = \frac{\partial ( - ρ )}{\partial t}$$

where (*) is the Hodge Star operator, (d) the differential operator and (ˆ) the wedge operator which joins the circular magnetic flux density B field with the electromagnetic wave (B_{wave}, E_{wave}).

Referring to FIG. 15, the interaction of the circular magnetic field (33), generated by the oscillating electric field (34), interacts with the radial electromagnetic field of the microwave beams (31) of the waveguides (30) to generate negative energy (32) over the sloping hull (35).

This combination of fields also creates the wormhole field over the hull. The spacetime curvature pressure T in the vertical z-direction is equal to the square of the circular magnetic flux density field

$${T}^{zz} = \frac{{B}^{2}}{8 π}$$

This stress-energy-momentum tensor can be thought of as a spacetime curvature proportional to the inverse of the radius squared, or as a pressure term which acts on the surface area of the hull. Thus there is the combination of a pressure stress and negative energy which creates the wormhole field over the sloping hull. Even though the magnetic flux density B field is oscillating, it is the square of the field which creates the stress. Thus the tension is still in the positive vertical z-direction.

Due to the low speed of light of hyperspace, the hyperspace energy is low density. Thus there is a positive gravitational potential between hyperspace and our dimension such that the hyperspace energy flows through the wormholes and onto the hull of the spacecraft. When this happens, a white mist forms over the hull. The effect of the hyperspace energy is to lessen the mass of the spacecraft, and relativistically increase the strength of the electromagnetic fields due to the smaller speed of light.

Referring to FIG. 16, the circular magnetic flux density field (36) is interacting with the magnetic monopole (37). The monopole acts as one pole of a magnet and therefore has a magnetic moment equal to the area times the electrical current circulating through it as the electrons move from our dimension into hyperspace. The great physicist Maxwell (1870) pointed out that the energy associated with charges and poles is potential energy and that therefore these objects tend to move in a direction that will decrease the potential energy, similar to a brick sliding down an inclined plane. Now to reduce the potential energy is the same as to reduce the field which gives a measure of the potential energy. If two like charges are brought together they strengthen one another's field, while opposite charges reduce one another's field. Thus like charges repel and unlike ones attract.

However, the energy associated with electric currents is not potential but kinetic in origin, because it is associated with moving charges. Now in mechanics it is well known that bodies move in a direction to increase their kinetic energy, if there is a source of external energy. The magnetic field of currents is a measure of kinetic energy and currents will try to move in a direction that will increase the field. Thus similarly-directed currents attract and unlike currents repel. In FIG. 16, the monopole will act so as to increase the field of the circular magnetic B field generated by the spacecraft. The monopole will then rotate into alignment with the flux tube. This increases the field strength of the flux tube. There is a torque τ on the monopole equal to the cross product of the magnetic moment with the B field
τ=μ×B

Referring to FIG. 17, when the monopole is aligned with the flux tube, the cross product is zero and there is zero torque on the monopole. Notice that even if the oscillating B field points in the opposite direction, there is still zero torque since the torque depends on the sine of the angle between them. The sin(0°) or sin(180°) is the same zero value. With the monopole aligned with the flux tube, the kinetic energy is now maximized. That is, both the flux tube and the monopole point in the θ-direction.

The magnetic B field can be represented as a vector having three components. The only component is in the angular direction
B={Bᵣ,B_{θ},B_{z}}={0, B_{θ}(z), 0}
where the field varies, as was seen in FIG. 13, in the vertical z-direction. The magnetic monopole field also points in the θ-direction
μ={0,μ_{θ}(z),0}
where there is a negative gradient of the monopole field in the z-direction due to the location of the microwave waveguides near the sloping hull.

The force F on the monopole is the gradient of the monopole's magnetic moment μ with the magnetic flux density B field
F=∇(μ·B)={0, 0, μ_{θ} B_{θ}^{′}(z)+B_{θ}(z)μ_{θ}^{′}(z)}
which says that there is a force on the monopole in the z-direction equal to the magnetic moment times the gradient of the magnetic field in the z-direction plus the magnetic field times the gradient of the magnetic moment in the z-direction.

Referring to FIG. 18. differentiating the magnetic field in the z-direction shows that the gradient is negative outside the hull. This can also be seen visually in FIG. 13 where the graphs decrease in intensity.

A negative gradient for both the magnetic moment and the field means that the force on the monopole is negative. The force on the tube connected to the hull is therefore the negative of a negative, yielding a positive lift force.
Fₘₒₙₒₚₒₗₑ=−{0, 0,|μ_{θ}B_{θ}^{′}(z)+B_{θ}(z)μ_{θ}^{′}(z)|}=−F_{tube}
F_{tube}=+{0, 0,|μ_{θ}B_{θ}^{′}(z)+B_{θ}(z)μ_{θ}^{′}(z)|}
which says there is an upward lift force on the hull due to the combination magnetic monopole and flux tube. This lift force is in addition to the vertical lift force generated by the spacetime curvature created by the electromagnetic fields themselves.

### SUMMARY OF THE INVENTION

This invention is a spacecraft propulsion system that utilizes electromagnetic fields and microwaves to generate negative energy and a spacetime curvature over the hull. The hull consists of a hemispherical dome, a circular array of radial microwave waveguides, a sloping flat hull, and a shallow spherical hull on the bottom. Alternating current high voltage transformers connected to the dome and the sloping hull generate a curving oscillating electric field between the dome and the sloping hull. Due to this oscillation, a horizontal circular oscillating magnetic flux density B field is created around the dome.

By firing the microwaves at right angles to the B field, negative energy is created over the hull. The negative energy and spacetime curvature pressure generate wormholes between space and hyperspace. Because hyperspace has a low speed of light and positive gravitational potential, low density hyperspace energy flows through the wormholes and onto the hull. The effect of the hyperspace energy is to lessen the mass of the vehicle and to increase the strength of the electromagnetic fields. Because the resistance of hyperspace is less than the resistance of space, electrons spiral down the wormholes into hyperspace. This creates a magnetic field through the wormhole with one pole in our dimension and the other pole in hyperspace. Thus a field of magnetic monopoles is created over the hull.

The magnetic monopoles, which represent kinetic energy, align themselves with the magnetic flux tubes in order to maximize the total magnetic field. Because there is a gradient of the monopoles and field in the vertical direction, a negative force develops on the monopoles equal to the gradient of the dot product of the magnetic moment of the monopole with the B field. Thus the opposite reaction is a positive force on the flux tubes attached to the hull which is equivalent to bringing the north pole of a magnet together with the south pole of a second magnet. Because the hull constantly regenerates the wormhole field, the hull experiences a constant upward lift force. This is in addition to the lift generated by the spacetime curvature pressure which is proportional to the square of the magnetic flux density B field.

### A BRIEF DESCRIPTION OF THE DRAWINGS

FIG. 1. Perspective view of cylindrical coordinate system {r, θ, z}.

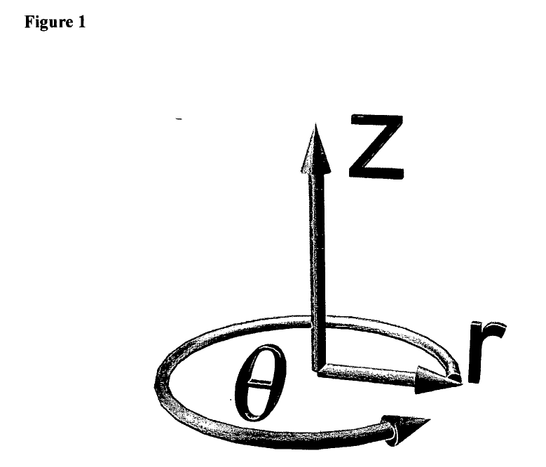

FIG. 2. Perspective view of tetrahedron circumscribed by sphere.

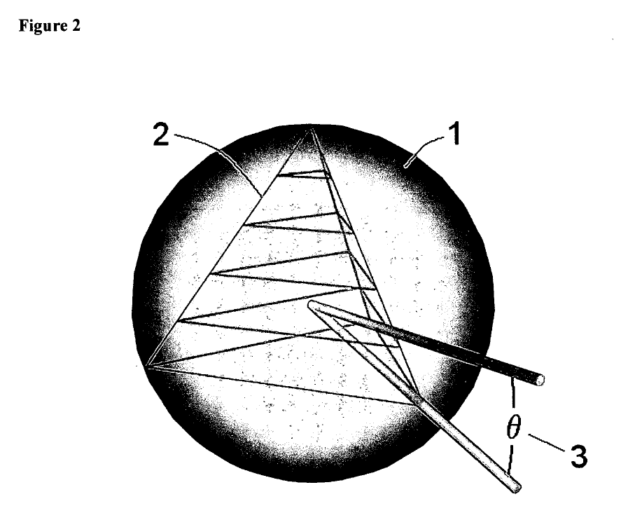

FIG. 3. Tetrahedron diagram showing speed of light squared is determined by the tetrahedron.

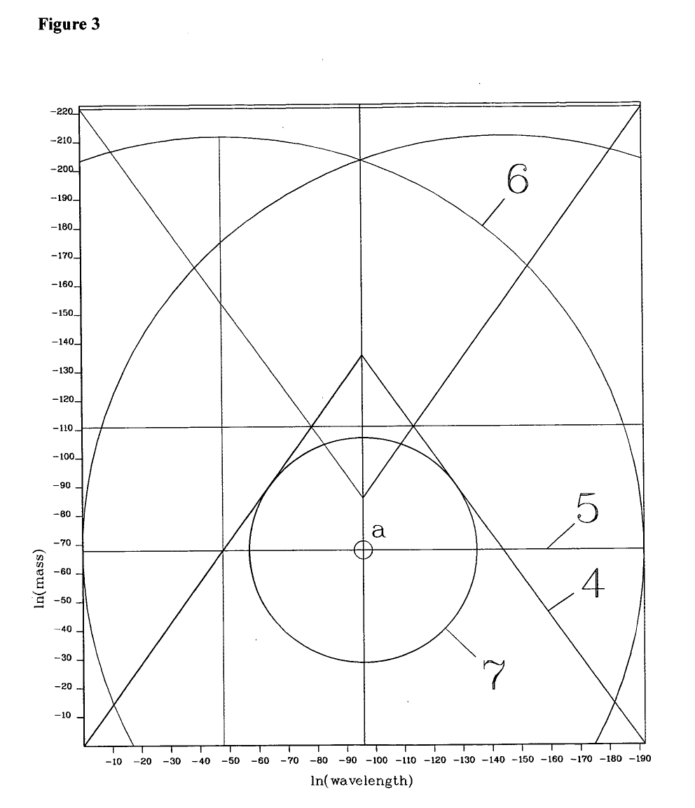

FIG. 4. Complex number z representation in the complex plane.

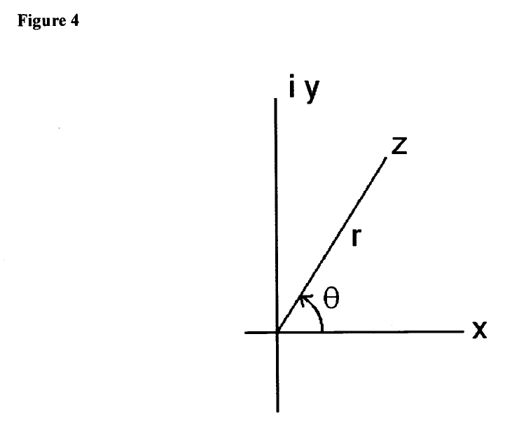

FIG. 5. Perspective view showing multiple log manifold hyperspace dimensions.

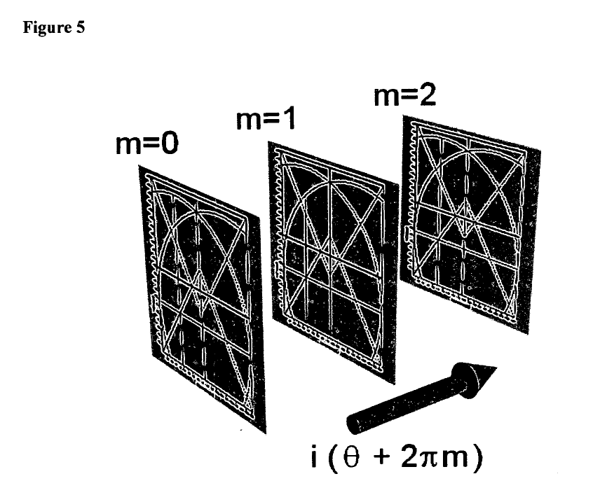

FIG. 6. Perspective view of orthogonal hyperspace dimensions.

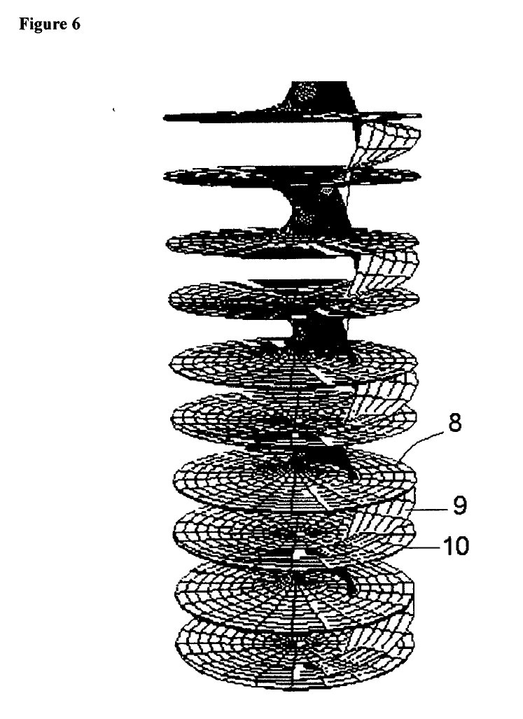

FIG. 7. Perspective view of Log[z] showing cut along origin.

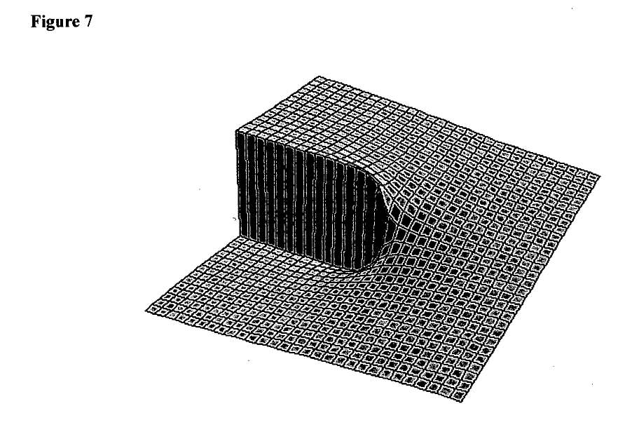

FIG. 8. Perspective view of charge phase shift around a magnetic flux.

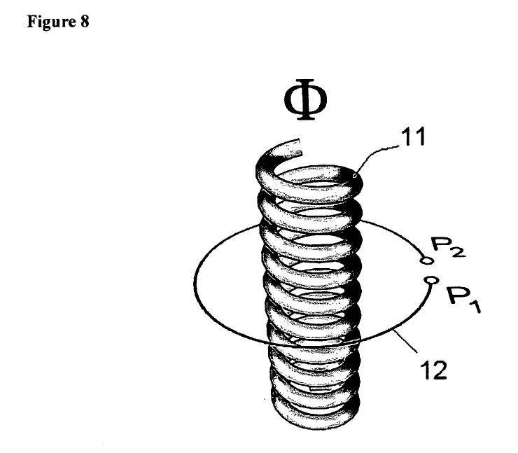

FIG. 9. Perspective view of wormhole magnetic flux density B field.

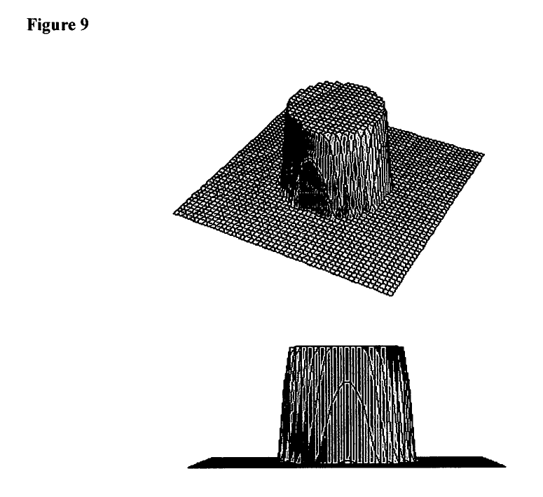

FIG. 10. Perspective view of magnetic monopole wormhole.

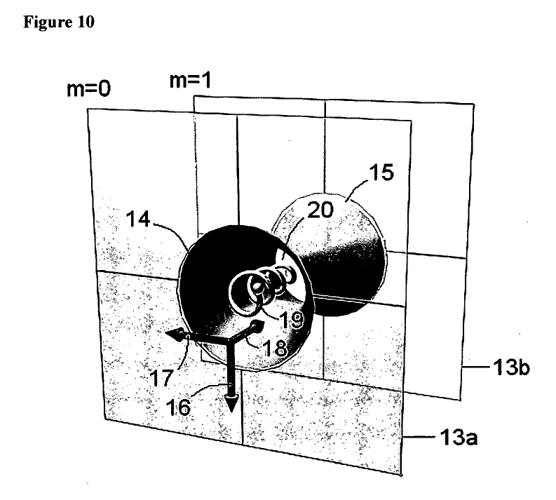

FIG. 11. Perspective view of spacecraft.

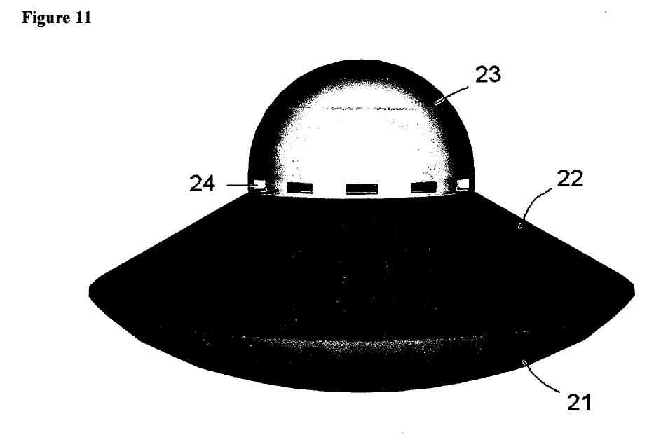

FIG. 12. Graph showing electrostatic potential and electric field over dome.

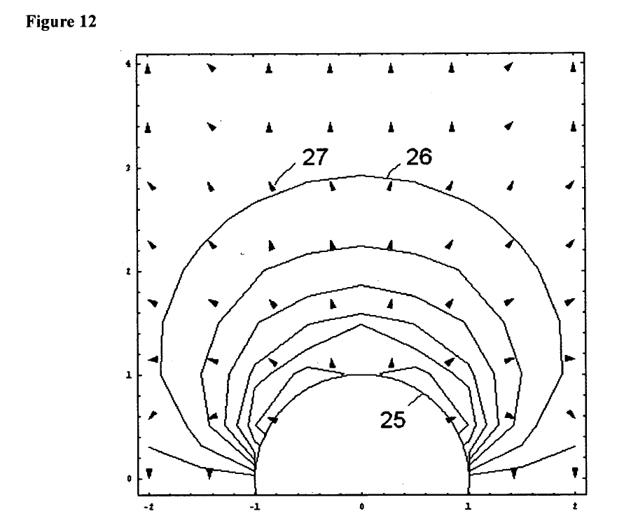

FIG. 13. Animation showing circular magnetic field around dome at increasing elevation.

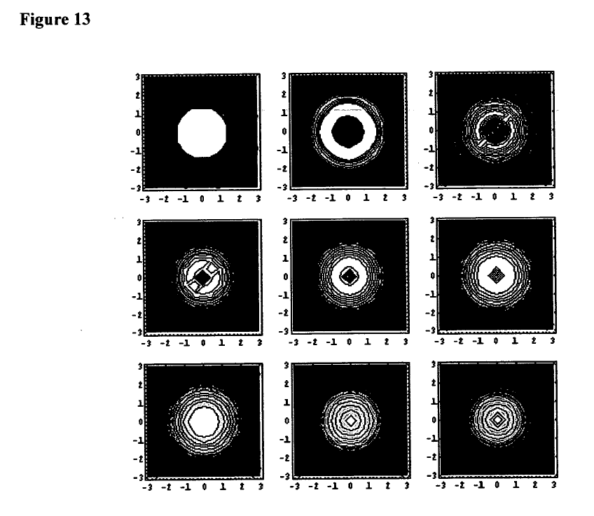

FIG. 14. Perspective view of electric and magnetic fields around hull.

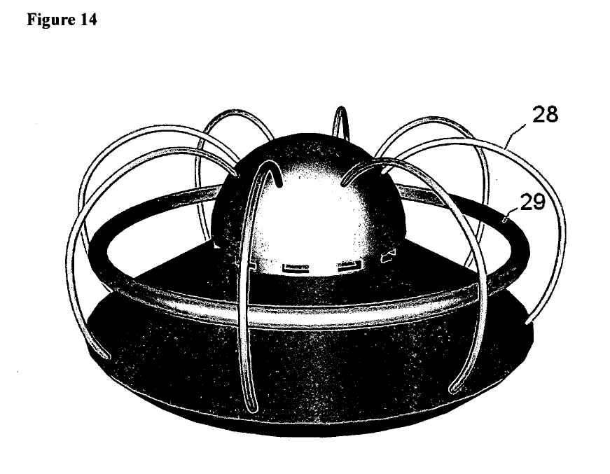

FIG. 15. Perspective view of generation of negative energy.

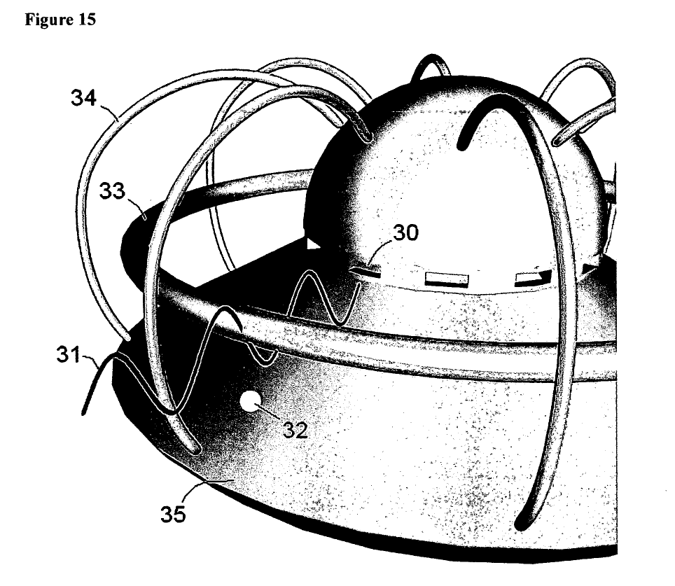

FIG. 16. Perspective view of monopole misaligned with flux tube with torque.

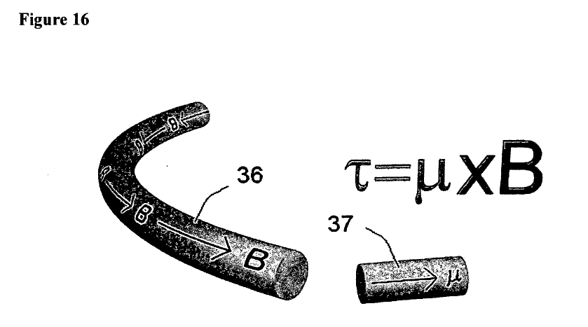

FIG. 17. Perspective view of monopole aligned with flux tube at zero torque.

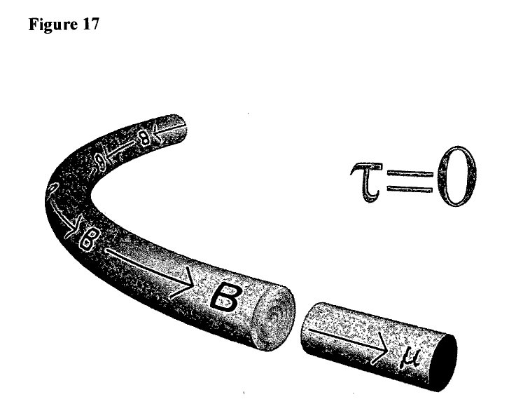

FIG. 18. Graph showing negative gradient of flux tube in the z-direction.

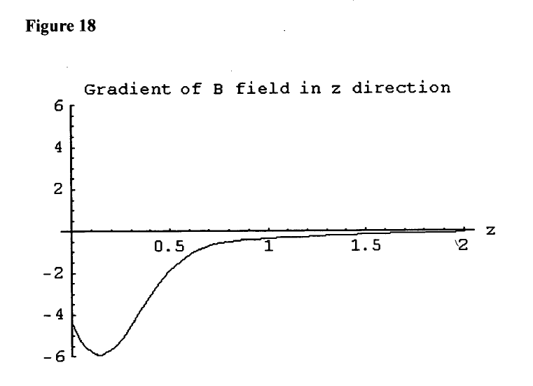

### DETAILED DESCRIPTION OF THE INVENTION

1. The aluminum hull is made by a technique called stretch forming which uses hydraulic cylinders to stretch a large sheet of aluminum to its yield point. This makes the aluminum sheet soft and pliable. Using a die which has been CNC machined to the desired hull profile, the sheet is then die pressed into a very rigid, smooth and lightweight structure requiring no other support. There are actually three dies consisting of a spherical dome, sloping hull, and shallow spherical dome.

2. The rest of the hull consists of a cylindrical hull with a radius equal to the upper dome. A segment of this hull is designed on a 3D computer graphics program and stored as a stereolithography *.stl file. The file is then transmitted over the Internet to a server who prints up the part on an xy-plotter with an ultraviolet laser and ultraviolet light sensitive polymer bath. The computer model is sliced by a special program into many thousands of slices which are printed one over the other until the part is completed. The server returns the part next day by Express Mail. Several parts are then molded using liquid plastic such as to form the complete ring. A sand mold is then constructed from all the molds to form a plastic cylindrical hull having the waveguide slots molded into it. The waveguide silver-coated aluminum boxes are then installed in the slots and connected to the frequency generators and amplifiers. The purpose of the plastic waveguide cylinder is to separate the electrostatic charges on the dome and the sloping hull In this particular case we used a dome from another spacecraft design which saved on the cost of the die.

I claim:

1. A spacecraft propulsion system consisting of the following components:
a lower hull made of aluminum sheet having a shallow spherical profile;
a circular flat sloping hull made of aluminum sheet attached to the top of the lower hull on the periphery;
an electrically-insulated plastic-molded tubular cylindrical hull containing slots for mounting an array of radial microwave waveguides, attached to top of the flat sloping hull;
a hemispherical cupola in the shape of a dome made of aluminum sheet mounted on top of the insulated cylindrical hull;
an array of rectangular microwave waveguides mounted in the waveguide slots of the cylindrical hull;
a high-voltage alternating current transformer with one side electrically attached to the upper dome and the other side electrically attached to the flat sloping hull; and
a frequency generator and amplifier to drive the microwave waveguides.

2. By means of claim (1), an oscillating electric field is created between the upper dome and the sloping hull using the high-voltage alternating current transformer.

3. By means of claim (2), an oscillating circular magnetic flux density field is generated around the sloping hull and upper dome.

4. By means of claims (1) and (3), negative energy is generated by the radial microwave beams of the waveguide array impinging on the circular magnetic flux density field around the hull.

5. By means of claim (3), a positive spacetime curvature pressure constituting a lift force is developed over the hull in the vertical direction proportional to the square of the field.

6. By means of claims (4) and (5), a field of wormholes between space and hyperspace are generated over the hull.

7. By means of claim (6), due to the positive gravitational potential between hyperspace and space, low-density hyperspace energy flows through the wormholes onto the hull to reduce the mass of the spacecraft and strengthen relativistically the electromagnetic fields.

8. By means of claim (6), electrons, emitted by the charged hulls, spiraling down the wormholes, generate a field of magnetic monopoles with one pole in space and the other in hyperspace.

9. By means of claims (6) and (3), the magnetic monopoles maximize their kinetic field energy by aligning with the magnetic flux tube.

10. By means of claim (9), the gradient in the vertical direction of the dot product of the magnetic moments of the monopoles with the magnetic flux density field is a negative force on the monopoles and an equal but opposite positive lift force on the magnetic flux tubes attached to hull.

11. By means of claims (10) and (5), a dual method of providing apositive lift force on the spacecraft is constituted.
